(19) United States
(12) Patent Application Publication
(10) Pub. No.: US 2014/0173175 A1
(43) Pub. Date: Jun. 19, 2014

(54) NAND COMMAND AGGREGATION

(71) Applicants: Ho-Fan Kang, San Diego, CA (US); Lan Dinh Phan, Trabuco Canyon, CA (US)

(72) Inventors: Ho-Fan Kang, San Diego, CA (US); Lan Dinh Phan, Trabuco Canyon, CA (US)

(73) Assignee: Virtium Technology, Inc., Rancho Santa Margarita, CA (US)

(21) Appl. No.: 13/715,848

(22) Filed: Dec. 14, 2012

(51) Int. Cl. G06F 12/02

(52) U.S. Cl. CPC G06F 12/0246
USPC 711/103

(57) ABSTRACT

An embodiment is a method and apparatus to provide an optimization of commands in a flash device. Commands sent by at least a top-level processor to a flash device are buffered in a buffer. The buffered commands are analyzed for an optimizing condition. The commands are aggregated if the optimizing condition is met. The aggregated commands are sent to the flash device.

### TECHNICAL FIELD

The presently disclosed embodiments are directed to the field of flash devices, and more specifically, to control and commands in flash devices.

### BACKGROUND

Flash memory devices (e.g., NAND flash devices) have become increasingly popular in data storage for computer systems, mobile devices, consumer devices (e.g., cameras). In many applications, it is important for flash devices to achieve high performance to satisfy the applications demands.

In a typical system that employs flash devices, there may be several top-level devices that communicate with a flash device such as the host processor, garbage collector, or wear level processor. In normal scenarios, these devices operate independently and may not be aware of each other's tasks. Accordingly, commands sent by these devices to the flash device may not be optimally controlled, leading to inefficiency.

One disclosed feature of the embodiments is a method and apparatus to provide an optimization of commands in a flash device. Commands sent by at least a top-level processor to a flash device are buffered in a buffer. The buffered commands are analyzed for an optimizing condition. The commands are aggregated if the optimizing condition is met. The aggregated commands are sent to the flash device

### BRIEF DESCRIPTION OF THE DRAWINGS

Embodiments may best be understood by referring to the following description and accompanying drawings that are used to illustrate embodiments. In the drawings:

FIG. 1 is a diagram illustrating a system according to one embodiment.

FIG. 2 is a diagram illustrating a flash domain manager according to one embodiment.

FIG. 3 is a flowchart illustrating a process to perform optimizing commands according to one embodiment.

FIG. 4 is a flowchart illustrating a process to analyze buffered commands according to one embodiment.

FIG. 5 is a flowchart illustrating a process to aggregate analyzed commands according to one embodiment.

### DETAILED DESCRIPTION

One disclosed feature of the embodiments is a technique to provide an optimization of commands in a flash device. Commands sent by at least a top-level processor to a flash device are buffered in a buffer. The buffered commands are analyzed for an optimizing condition. The commands are aggregated if the optimizing condition is met. The aggregated commands are sent to the flash device.

In the following description, numerous specific details are set forth. However, it is understood that embodiments may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

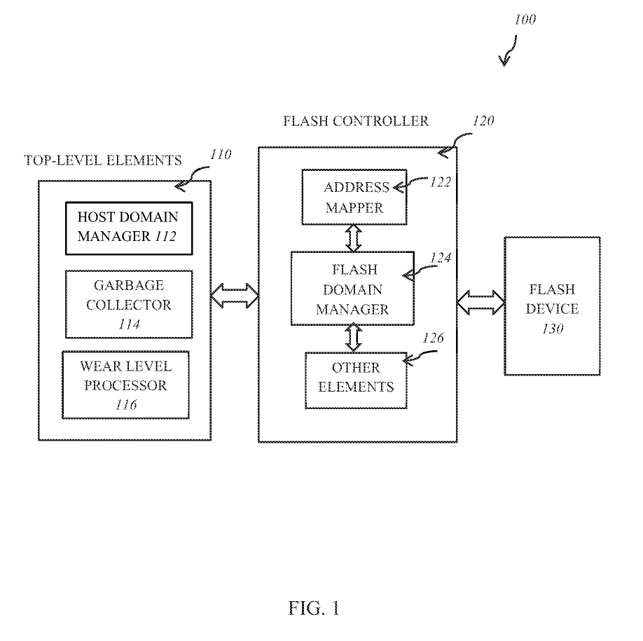

FIG. 1 is a diagram illustrating a system 100 according to one embodiment. The system 100 includes a plurality of top-level elements 110, a flash controller 120, and a flash device 130. The system 100 may include more or less than the above components. For example, the flash controller 120 may be integrated with any one of the top-level elements 110, or components in the flash controller 120 may be separately implemented, or there may be additional peripheral devices or controllers that are connected to the top-level element 110 such as a network device, a set of memory devices, etc. In addition, there may be only one top-level element 110.

The plurality of top-level elements 110 refer to firmware elements that represent functionalities performed by a processor. They essentially represent virtual elements, not physical processors. They may include a host domain manager 112, a garbage collector 114, and a wear-level processor 116. The host domain manager 112 may include any element that operates at the host domain. It may be performed by a general-purpose microprocessor, a digital signal processor (DSP), a special-purpose processor, an embedded controller, or any programmable device or processor that may execute a program or a set of instructions. The garbage collector 114 may be an element to perform garbage collection for the flash device 130. The wear level processor 116 may be an element to perform any wear level operation on the flash device 130 such as dynamic or static wear-level operations, program/erase operation that generates special pulses and voltage level shifting and timing and control signals to perform block erasure and program/write to the flash device 130.

The commands issued or sent by the top-level elements 110 may be any commands that operate on the flash device 130. They may be a write command, a read command, or an erase/program command. Typically, these commands include two basic fields: an operation field (e.g., write, read, or erase) and an address field. The address field corresponds to the destination in the flash device 130 for the command. For example, the commands may be write to block 000, read from block 001, erase block 010, etc. Each of the top-level elements 110 may have its own buffer to buffer its commands.

The flash controller 120 may be any device or processor that is designed to interface to the flash device 130 for the purpose of interfacing to or controlling the operations on the flash device 130. The flash controller 120 may be implemented in hardware, software, firmware, or any combination of hardware, software, and firmware. The flash controller 120 may include an address mapper 124, a flash domain manager 124, and other elements 126. The flash controller 120 may include more or less than the above components. In addition, these components may be separated from each other, or integrated fully or partly into the top-level element 110.

The address mapper 122 may receive the logical address in the address field of the commands directly from the top-level processor 110. It may map or translate a logical address issued from the top-level processor 110 to a physical address that is used to specifically address the blocks in the flash device 130. It may be implemented as a look-up table or any other convenient and efficient mapping technique.

The flash domain manager 124 provides flash domain operations to the flash device 140. In one embodiment, these flash domain operations include optimizing commands sent from the top-level element(s) 110. The optimization is to improve efficiency or performance of the flash device 130 such as to increase the overall throughput. By delegating the task of optimizing the commands to the flash domain manager 124, each of the top-level elements 110 may be free to concentrate on its own individual operations and leave all the decisions of optimizing commands from all the elements 110 to the flash domain manager 124. Therefore, the flash domain manager 124 may reduce the overhead associated with each of the top-level elements 110 and at the same time may be able to perform intelligent decisions by virtue of having all of the commands issued from the top-level elements 110 available for analysis. The flash domain manager 124 obtains the address or destination of the commands from the address mapper 122.

The other elements 126 may include any other elements, either hardware or firmware, that may be included in the flash controller 120. These elements may include error correction code (ECC) processing, lifespan estimator, etc.

The flash device 130 may be any semiconductor flash memory device such as a NAND flash memory, a NOR flash memory. It may be a single die or a multiple die device. Typically, the flash device 140 may be used as a solid state drive (SSD). The flash device 140 may be organized in any configurations, such as 512 Mb to 128 Gb density, block size from 16K to 512K, page size from 512 to 8K, etc.

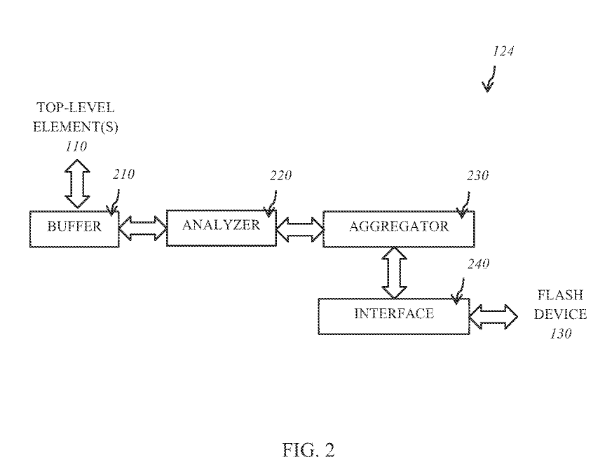

FIG. 2 is a diagram illustrating the flash domain manager 124 shown in FIG. 1 according to one embodiment The flash domain manager 124 may include a buffer 210, an analyzer 220, an aggregator 230, and an interface 240. The flash domain manager 124 may include more or less than the above components. For example, the analyzer 220 and the aggregator 230 may be combined into a single component. The flash domain manager 124 may be implemented in firmware or hardware or a combination of firmware and hardware.

The buffer 210 may buffer commands sent by at least one of the top-level elements 110 to the flash device 130. It may be implemented by a first-in-first-out (FIFO) device with sufficient depth to accommodate the number of commands to be issued by the top-level elements 110. It may have interface to the individual buffers in the top-level elements 110. At any time, the buffer 210 may contain a mixed set of commands sent from all of the top-level elements 110.

The analyzer 220 may analyze the buffered commands in the buffer 210 for an optimizing condition. It may start its operation each time a command is sent by one of the top-level elements 110. It may scan the all the buffered commands and took for an optimizing condition that may be satisfied by combining or aggregating commands. In one embodiment, the optimizing condition is related to a destination condition of the commands. The destination condition may correspond to the same destination of the command such that multiple commands may be performed at the same time, and thus achieve higher performance than if they are performed sequentially. For example, the optimizing condition may correspond to commands that operate on adjacent blocks of the flash device 130. The adjacent blocks may correspond to a dual plane in the flash device 130. If multiple commands have their destination correspond to adjacent blocks or multiple planes in the flash device 130, then these commands may be performed at the same time, thus increasing the throughput. For example, two write commands that correspond to two adjacent blocks can be aggregated so that two operations may be performed simultaneously, thus doubling the throughput.

The analyzer 220 may also perform dependency on the commands to ensure that any operation that may lead to contention or conflict will not be inadvertently carried out.

The aggregator 230 may aggregate the commands if the optimizing condition is met based on the result of the analysis by the analyzer 220. For example, if the analyzer 220 determines that a command X from the host domain manager 112 and a command Y from the garbage collector 114 have their destinations correspond to adjacent blocks in the flash device 130, it may mark these commands for aggregation. The aggregator 230 may then extract these marked commands from the buffer 210 and combine them to send to the flash device via the interface 240. In one embodiment, the aggregator 230 alters the commands to be aggregated before sending them to the buffer in the interface 240. The following example illustrates this process:

Operation 1: READ_PAGE

Operation 2: READ_PAGE

Optimizing condition is met:

Operation 1: READ_DUAL_PLANE_{—}1

Operation 2: READ_DUAL_PLANE_{—}2

In the above example, the aggregation is the altering of the operation codes of the two commands in Operation 1 and Operation 2. These altered commands are then sent to the buffer.

The interface 240 may send the commands that are aggregated by the aggregator 230 to the flash device 130. The interface 240 may also schedule the sending of these aggregated commands according to the status of the flash device 130 to achieve an improved overall performance.

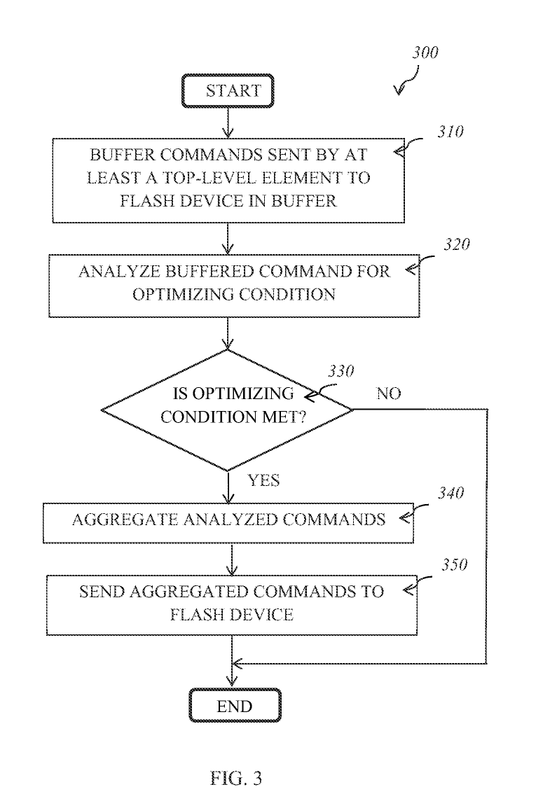

FIG. 3 is a flowchart illustrating a process 300 to perform optimizing commands according to one embodiment.

Upon START, the process 300 buffers commands sent by at least a top-level processor to a flash device in a buffer (Block 310). Then, the process 300 analyzes the buffered commands for an optimizing condition (Block 320). Next, the process 300 determines if the optimizing condition is met (Block 330). In other words, the process 300 determines if commands in the buffer may be aggregated to enhance performance. If no optimizing condition is met, the process 300 is terminated. If the optimizing condition is met, the process 300 aggregates the commands that correspond to the optimizing condition (Block 340). Next, the process 300 sends the aggregated commands to the flash device (Block 350) and is then terminated.

FIG. 4 is a flowchart illustrating the process 320 to analyze buffered commands according to one embodiment.

Upon START, the process 320 analyzes the dependency in the commands if necessary (Block 410). For example, if there is address dependency that may prevent aggregation of commands, the process 320 may indicate that situation and may resolve the conflict or may decide not to perform aggregation.

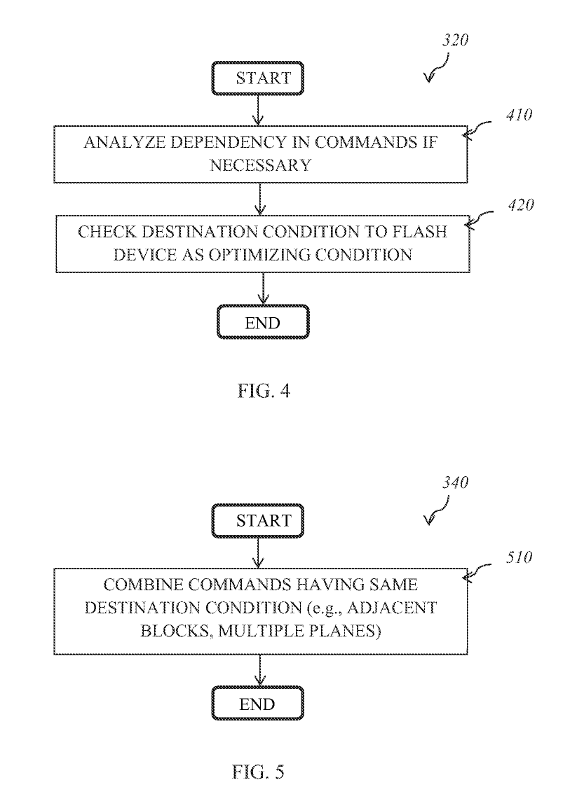

FIG. 5 is a flowchart illustrating the process 340 to aggregate analyzed commands according to one embodiment.

Upon START, the process 340 combines commands having same destination condition such that the commands may be performed at the same time (Block 510). For example, the same destination condition may correspond to adjacent blocks or multiple planes in the flash device. The combination may include the altering of the operation codes in the original commands that take advantage of the combined effect of the commands to achieve high speed. The process 340 is then terminated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any non-transitory medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
buffering commands sent by at least a top-level processor to a flash device in a buffer;
analyzing the buffered commands for an optimizing condition;
aggregating the commands if the optimizing condition is met; and
sending the aggregated commands to the flash device.

2. The method of claim 1 wherein buffering commands comprises:
buffering commands sent by at least one of a host domain manager, a garbage collector, and a wear-level controller.

3. The method of claim 1 wherein analyzing the commands comprises:
checking a destination condition to the flash device as the optimizing condition.

4. The method of claim 3 wherein aggregating the commands comprises:
combining commands having same destination condition.

5. The method of claim 4 wherein the same destination condition corresponds to adjacent blocks or multiple planes in the flash device.

6. The method of claim 1 wherein analyzing the commands further comprises:
analyzing dependency in the commands.

7. The method of claim 1 wherein the commands correspond to one of a write, a read, and an erase command.

8. A circuit comprising:
a buffer to buffer commands sent by at least a top-level processor to a flash device;
an analyzer coupled to the buffer to analyze the buffered commands for an optimizing condition;
an aggregator coupled to the analyzer to aggregate the commands if the optimizing condition is met; and
an interface to send the aggregated commands to the flash device.

9. The circuit of claim 8 wherein the buffer buffers commands sent by at least one of a host domain manager, a garbage collector, and a wear-level controller.

10. The circuit of claim 8 wherein the analyzer checks a destination condition to the flash device as the optimizing condition.

11. The circuit of claim 10 wherein the aggregator combines commands having same destination condition.

12. The circuit of claim 11 wherein the same destination condition corresponds to adjacent blocks or multiple planes in the flash device.

13. The circuit of claim 8 wherein the analyzer further analyzes dependency in the commands.

14. The circuit of claim 8 wherein the commands correspond to one of a write, a read, and an erase command.

15. A system comprising:
a plurality of top-level processors;
a flash device; and
a flash domain manager coupled to the plurality of top-level processors and the flash device to optimize commands sent by at least one of the top-level processors to the flash device, the flash domain manager comprising:
a buffer to buffer the commands,
an analyzer coupled to the buffer to analyze the buffered commands for an optimizing condition;
an aggregator coupled to the analyzer to aggregate the commands if the optimizing condition is met; and
an interface to send the aggregated commands to the flash device.

16. The system of claim 15 wherein one of the top-level processors is one of a host domain manager, a garbage collector, and a wear-level controller.

17. The system of claim 15 wherein the analyzer checks a destination condition to the flash device as the optimizing condition.

18. The system of claim 17 wherein the aggregator combines commands having same destination condition.

19. The system of claim 18 wherein the same destination condition corresponds to adjacent blocks or multiple planes in the flash device.

20. The system of claim 15 wherein the analyzer further analyzes dependency in the commands.

21. The system of claim 15 wherein the commands correspond to one of a write, a read, and an erase command.
